(19) United States
(12) Patent Application Publication
(10) Pub. No.: US 2011/0283212 A1
(43) Pub. Date: Nov. 17, 2011

(54) User Interface

(75) Inventor: Simon Thomas Warner, Farnborough (GB)

(73) Assignee: NOKIA CORPORATION, Espoo (FI)

(21) Appl. No.: 12/779,736

(22) Filed: May 13, 2010

(51) Int. Cl. G06F 3/048; G06F 3/033

(52) U.S. Cl. 715/769; 715/830; 715/863

(57) ABSTRACT

In accordance with an example embodiment of the present invention, there is provided a method comprising receiving an indication of a first drag input on a user interface object within a user interface on a touch screen and in response to receiving a stationary input on the touch screen, interpreting the first drag input as an instruction to detach the user interface object from the user interface.

### TECHNICAL FIELD

The present application relates generally to user interfaces.

### BACKGROUND

User interfaces can allow several different user operations. For example, touch screen user interfaces can recognize several different gestures, and cause several corresponding functions to be performed. In addition, multi-touch devices e.g. devices that allow and are capable of detecting more than one simultaneous touch, can enable an even larger range of touch gestures to perform functions. An aspect in usability studies is to try to provide a user with a possibility of providing intuitive gestures to cause corresponding functions to be performed.

### SUMMARY

Various aspects of examples of the invention are set out in the claims.

According to a first aspect of the present invention, there is provided a method comprising receiving an indication of a first drag input on a user interface object within a user interface on a touch screen and in response to receiving a stationary input on the touch screen, interpreting the first drag input as an instruction to detach the user interface object from the user interface.

According to a second aspect of the present invention, there is provided an apparatus comprising a processor, memory including computer program code, the memory and the computer program code configured to, working with the processor, cause the apparatus to perform at least the following: receive an indication of a first drag input on a user interface object within a user interface on a touch screen and in response to receiving a stationary input on the touch screen, interpret the first drag input as an instruction to detach the user interface object from the user interface.

According to a third aspect of the present invention, there is provided a computer program product comprising a computer-readable medium bearing computer program code embodied therein for use with a computer, the computer program code comprising code for receiving an indication of a first drag input on a user interface object within a user interface on a touch screen and code for interpreting the first drag input as an instruction to detach the user interface object from the user interface in response to receiving a stationary input on the touch screen.

According to a fourth aspect of the present invention there is provided an apparatus, comprising means for receiving an indication of a first drag input on a user interface object within a user interface on a touch screen and means for interpreting the first drag input as an instruction to detach the user interface object from the user interface in response to receiving a stationary input on the touch screen.

### BRIEF DESCRIPTION OF THE DRAWINGS

For a more complete understanding of example embodiments of the present invention, reference is now made to the following descriptions taken in connection with the accompanying drawings in which:

FIG. 1 shows a block diagram of an example apparatus in which aspects of the disclosed embodiments may be applied;

FIG. 2 shows a block diagram of another example apparatus in which aspects of the disclosed embodiments may be applied;

FIGS. 3a and 3b illustrate a user interface in accordance with an example embodiment of the invention;

FIGS. 4a to 4c illustrate another user interface in accordance with an example embodiment of the invention;

FIGS. 5a and 5b illustrate an example process incorporating aspects of the disclosed embodiments; and

FIG. 6 illustrates another example process incorporating aspects of the disclosed embodiments.

### DETAILED DESCRIPTION OF THE DRAWINGS

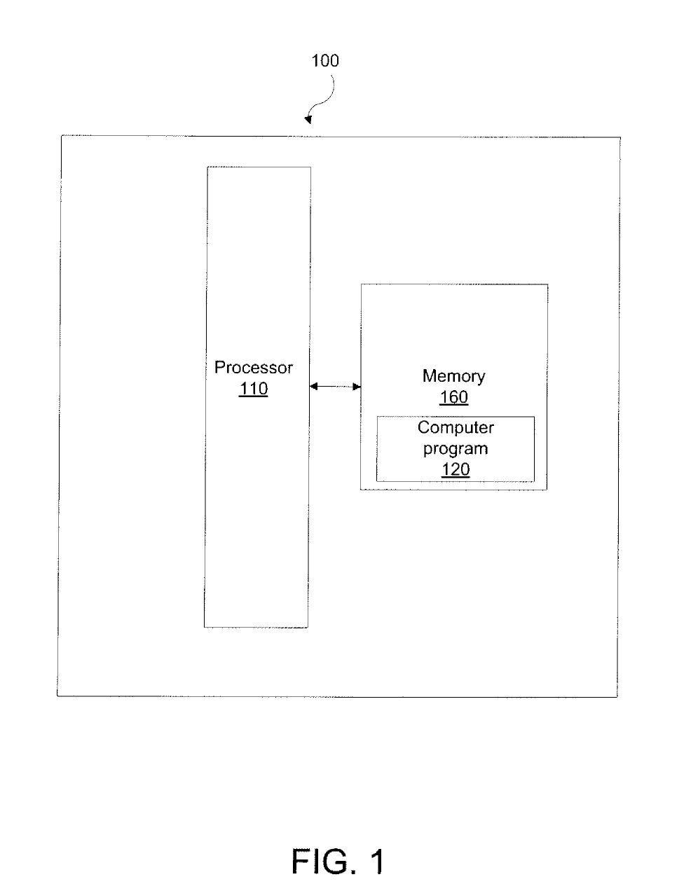

An example embodiment of the present invention and its potential advantages are understood by referring to FIGS. 1 through 6 of the drawings.

The aspects of the disclosed embodiments relate to user operations on an apparatus. In particular, some examples relate to distinguishing between different user operations on a touch screen. In some example embodiments a technique for interpreting a user input is disclosed. In some example embodiments a user input comprises a touch gesture on a touch screen. In some examples the touch gesture comprises a multi-touch gesture i.e. multiple touches on a touch screen at least partially simultaneously. In some example embodiments a touch gesture comprises a drag gesture. In some example embodiments a touch gesture comprises a combination of a drag gesture and a stationary input. In some example embodiments a technique for interpreting a drag gesture is disclosed. In some examples a drag gesture may comprise an instruction to detach an item from a user interface.

FIG. 1 is a block diagram depicting an apparatus 100 operating in accordance with an example embodiment of the invention. The apparatus 100 may, for example, be an electronic device such as a chip or a chip-set. Generally, the apparatus 100 includes a processor 110 and a memory 160. In another example embodiment the apparatus 100 may comprise multiple processors.

In the example of FIG. 1, the processor 110 is a control unit that is connected to read from and write to the memory 160. The processor 110 may also be configured to receive control signals to the processor 110 received via an input interface and/or the processor 110 may be configured to output control signals by the processor 110 via an output interface.

The memory 160 stores computer program instructions 120 which when loaded into the processor 110 control the operation of the apparatus 100 as explained below. In another example embodiment the apparatus 100 may comprise more than one memory 160 or different kinds of storage devices.

In one example embodiment the processor 110 may be configured to convert the received control signals into appropriate commands for controlling functionalities of the apparatus. In another example embodiment the apparatus may comprise more than one processor.

Computer program instructions 120 for enabling implementations of example embodiments of the invention or a part of such computer program instructions may be downloaded from a data storage unit to the apparatus 100 by the manufacturer of the apparatus 100, by a user of the apparatus 100, or by the apparatus 100 itself based on a download program or the instructions can be pushed to the apparatus 100 by an external device. The computer program instructions may arrive at the apparatus 100 via an electromagnetic carrier signal or be copied from a physical entity such as a computer program product, a memory device or a record medium such as a CD-ROM or DVD.

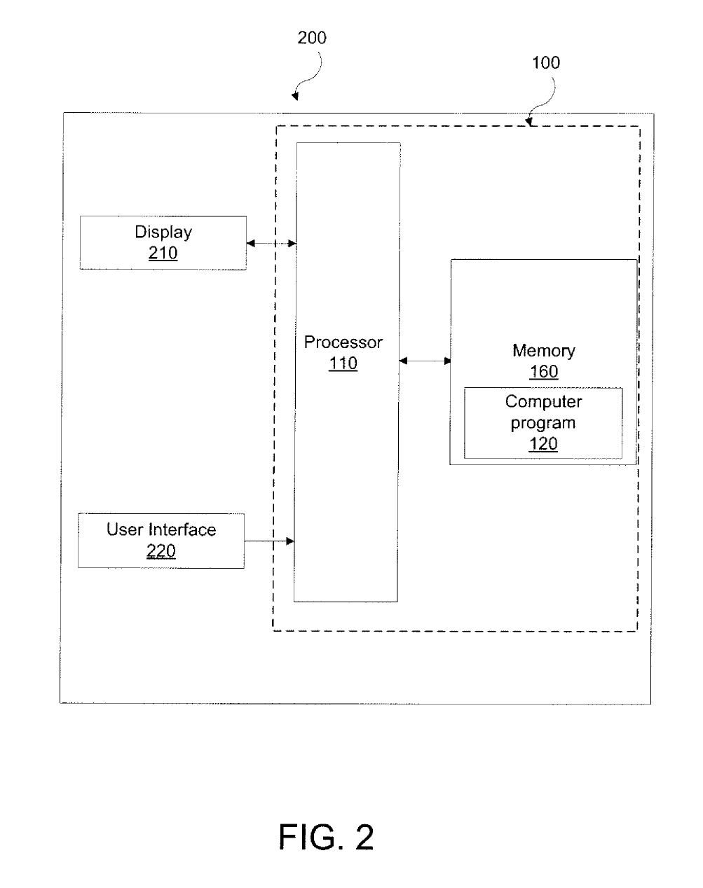

FIG. 2 is a block diagram depicting a further apparatus 200 operating in accordance with an example embodiment of the invention. The apparatus 200 may be an electronic device such as a hand-portable device, a mobile phone or a personal digital assistant (PDA), a personal computer (PC), a laptop, a desktop, a wireless terminal, a communication terminal, a game console, a music player, a CD- or DVD-player or a media player.

Generally, the apparatus 200 includes the apparatus 100, a user interface 220 and a display 210. The user interface 220 comprises means for inputting and accessing information in the apparatus 200. In one example embodiment the user interface 220 may also comprise the display 210. For example, the user interface 220 may comprise a touch screen display on which user interface objects can be displayed and accessed. In one example embodiment, a user may input and access information by using a suitable input means such as a pointing means, one or more fingers, a stylus or a digital pen. In one embodiment inputting and accessing information is performed by touching the touch screen display. In another example embodiment proximity of an input means such as a finger or a stylus may be detected and inputting and accessing information may be performed without a direct contact with the touch screen. In a further example embodiment the touch screen display is configured to detect multiple at least partially simultaneous touches on the touch screen.

In another example embodiment, the user interface 220 comprises a manually operable control such as button, a key, a touch pad, a joystick, a stylus, a pen, a roller, a rocker or any suitable input means for inputting and/or accessing information. Further examples are a microphone, a speech recognition system, eye movement recognition system, acceleration, tilt and/or movement based input system.

The example apparatus 200 of FIG. 2 also includes an output device. According to one embodiment the output device is a display 210 for presenting visual information for a user. The display 210 is configured to receive control signals provided by the processor 110. The display 210 may be configured to present user interface objects. However, it is also possible that the apparatus 200 does not include a display 210 or the display is an external display, separate from the apparatus itself. According to one example embodiment the display 210 may be incorporated within the user interface 220.

In a further embodiment the apparatus 200 includes an output device such as a tactile feedback system for presenting tactile and/or haptic information for a user. The tactile feedback system may be configured to receive control signals provided by the processor 110. The tactile feedback system may be configured to indicate a completed operation or to indicate selecting an operation, for example. In one embodiment a tactile feedback system may cause the apparatus 200 to vibrate in a certain way to inform a user of an activated and/or completed operation.

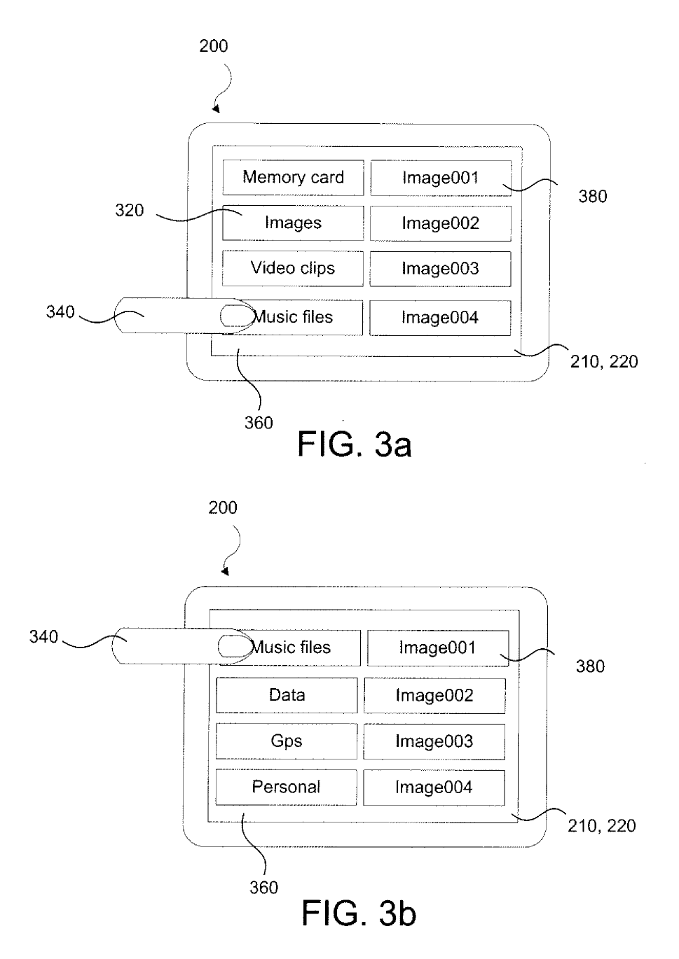

FIGS. 3a and 3b illustrate an example user interface incorporating aspects of the disclosed embodiments. An apparatus 200 comprises a display 210 for presenting user interface objects. In one example embodiment the display 210 of the apparatus 200 comprises a touch screen display incorporated within the user interface 220 which allows inputting and accessing information via the touch screen. The example apparatus 200 of FIG. 3 may also comprise one or more keys and/or additional and/or other components.

The example user interface of FIGS. 3a and 3b comprises a file manager application such as a gallery application 360 comprising user interface objects 320 such as multiple files and/or folders visually presented to a user. In the example of FIGS. 3a and 3b, the gallery application 360 displays user interface objects 320 comprising folders such as “Images”, “Video clips”, “Music files” and available storage devices such as “Memory Card”. More folders and/or files may be displayed by scrolling the screen. Folders may also comprise user interface objects such as images, videos, text documents, audio files or other items that are displayed to a user. For example, the “Images” folder may comprise images created by a user or received by a user, the “Video clips” folder may comprise video files and the “Music files” may comprise audio files. The “Memory Card” user interface object may represent a possibility to store files and/or folders on a separate memory card included in the device 200. The example of FIGS. 3a and 3b also presents other user interface objects such as images files 380.

FIGS. 3a and 3b also illustrate an example method for scrolling the user interface by directly manipulating the touch screen 210. By placing his finger 340, stylus or any other suitable pointing means on any point on the touch screen and dragging the pointing means on the touch screen, a user can scroll the user interface including the user interface objects.

In the example of FIG. 3a, a user has placed his finger 340 on the touch screen on top of the “Music files” folder. The user can scroll the user interface 220 by moving his finger on the touch screen and then releasing the touch at an end point. For example, in FIG. 3a the user starts scrolling the user interface to reveal folders beneath the “Music files” folder by placing his finger on top of the “Music files” folder, dragging his finger on the touch screen to move the “Music files” folder towards the upper edge of the device 200 and releasing the touch when the “Music files” is the first visible list item at the top. In this way, the user can hide the “Memory Card”, the “Images” folder and the “Video clips” folder by scrolling them to outside the display area 210 and reveal a “Data” folder, a “GPS” folder and a “Personal” folder by scrolling them to inside the display area 210 as illustrated in FIG. 3b. The scrolled folders remain in the same position in relation to the “Music files” folder. By the illustrated method a user can scroll a user interface including user interface objects. In the example of FIGS. 3a and 3b, scrolling the folders may be performed independent of the image files “Image001”, “Image002”, “Image003” and “Image004” so that the image files remain stationary. According to another example embodiment the image files may be scrolled independent of the folders. According to a further example embodiment the image files may be scrolled simultaneously with the folders. In other words, the user interface 220 may be scrolled in parts or the whole user interface may be scrolled together. In these cases the user interface is scrolled together with the user interface objects positioned in the scrolled part of the user interface. In the examples described above, the scrolling operations are performed in one dimension. Other scrolling examples may involve a second dimension, so that a display may be shifted in the left-right direction in addition to (or instead of) the up-down direction. According to one example embodiment, different kinds of guidance means may be provided for the user to indicate his current position in the gallery application 360. A guidance means may comprise a scroll bar, a visual indication or a feedback system.

In some example embodiments a user interface object may be any image or image portion that is presented to a user on a display. In some example embodiments a user interface object may be any graphical object that is presented to a user on a display. In some example embodiments a user interface object may be any selectable and/or controllable item that is presented to a user on a display. In some example embodiments a user interface object may be any information-carrying item that is presented to a user on a display. In some embodiments an information-carrying item comprises a visible item with a specific meaning to a user. In another embodiment the user interface objects presented by the display 210 may additionally or alternatively comprise a part of an application window and/or other user interface objects such as icons, files, folders, widgets or an application such as a web browser or a gallery application, for example.

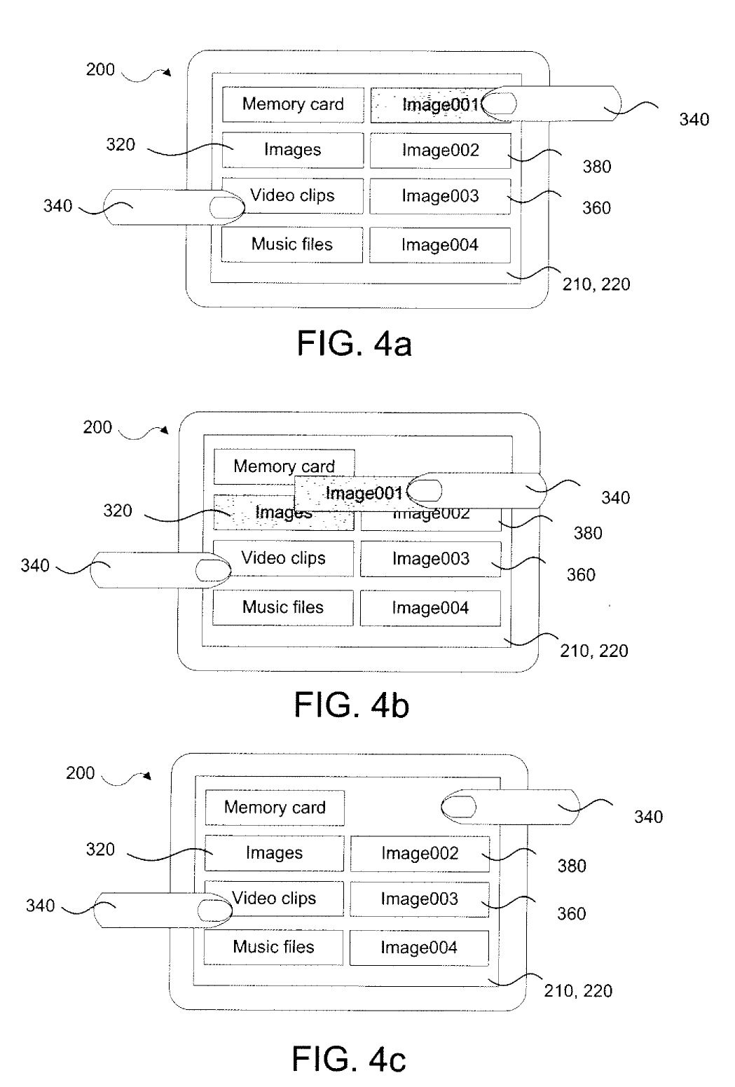

FIGS. 4a to 4c illustrate another example user interface incorporating aspects of the disclosed embodiments. An apparatus 200 comprises a display 210 for presenting user interface objects. In this example embodiment the display 210 of the apparatus 200 is a touch screen display incorporated within the user interface 220 which allows inputting and accessing information via the touch screen. In one example embodiment the touch screen is configured to receive two or more at least partially simultaneous touches. The example apparatus 200 of FIG. 4 may also comprise one or more keys and/or additional and/or other components.

The example user interface of FIGS. 4a to 4c comprises a file manager application such as a gallery application 360 comprising user interface objects such as multiple files and/or folders visually presented to a user. In the example of FIG. 4, the gallery application 360 displays user interface objects 320 comprising folders such as “Images”, “Video clips”, “Music files” and available storage devices such as “Memory Card” similarly to the example of FIGS. 3a and 3b. Similarly to the example of FIGS. 3a and 3b, the example of FIGS. 4a to 4c also presents other user interface objects such as an image file 380.

FIGS. 4a to 4c also illustrate a method for moving user interface objects independently of the user interface. According to one example embodiment a user may detach a user interface object included in a user interface from the user interface by a specified touch gesture, thereby enabling the object to be moved relative to the remainder of the user interface. According to one example embodiment a touch gesture for detaching a user interface object comprises a multi-touch gesture. According to another example embodiment a touch gesture for detaching a user interface object comprises a combination of two or more single touch gestures. According to a further embodiment a touch gesture for detaching a user interface object comprises a combination of two or more multi-touch gestures. According to a yet further embodiment a touch gesture for detaching a user interface object comprises a combination of a single touch gesture and a multi-touch gesture.

In the example of FIGS. 4a to 4c and similar to the example of FIGS. 3a and 3b, the user can scroll the user interface 220 by moving his finger on the touch screen and then releasing the touch. According to one example embodiment the user can scroll the user interface as a whole in terms of scrolling all the user interface objects simultaneously. According to another example embodiment the user interface may be divided so that the user can scroll the user interface in parts. For example, in FIGS. 4a to 4c, the user may scroll the folders 320 on the left hand side independent of the files on the right hand side and vice versa. In the scrolled part of the user interface the user interface objects remain in the same position in relation to each other. Similar to the example of FIGS. 3a and 3b, the scrolling operations may involve a second dimension so that a display may be shifted in the left-right direction in addition to (or instead of) the up-down direction.

Referring back to the example of FIG. 4a, the user scrolls the user interface 220 by a drag gesture. According to one example embodiment, scrolling the user interface 220 may be initiated by a touch on any place on the touch screen. According to another example embodiment, scrolling the user interface 220 may be initiated on any empty area on the touch screen.

In response to additionally receiving a separate, stationary, input on the touch screen, a processor 110 interprets the drag input as an instruction to detach the user interface object from the user interface. For example, in FIG. 4a the user scrolls the user interface 220 by placing his finger on top of the “Image001” file and dragging his finger 340 on the touch screen. In response to receiving information on a second finger, stationary on the “Video Clips” folder as illustrated in FIG. 4a, the processor 110 interprets the drag input as an instruction to detach the “Image001” file from the user interface 220 and move it independently of the user interface 220 in relation to the user interface 220. A change from a drag operation to a move operation may be indicated to the user, for example, visually, audibly, haptically or in any combination thereof. For example, the appearance of a user interface object to be moved may be changed as illustrated in FIG. 4a in terms of changing the background color of the “Image001” file.

According to one example embodiment a touch gesture for detaching a user interface object comprises a substantially stationary gesture. For example, a user may perform the gesture by placing his thumb or a finger on the touch screen and keeping it substantially motionless. According to another example embodiment a touch gesture for detaching a user interface object comprises a gesture the intensity of which is above a pre-determined pressure level. In other words, a processor may be configured to receive information on different pressure levels leveled against the touch screen, and a touch gesture with an intensity above a pre-determined pressure level may be interpreted as an instruction to detach a user interface object from the user interface.

According to one example embodiment a gesture for detaching a user interface object may be performed on any part of the user interface 220. According to another example embodiment a gesture for detaching a user interface object may be performed on an empty area of the user interface 220. According to a further example embodiment a gesture for detaching a user interface object may be performed on a predefined area of the user interface 220.

According to an example embodiment a processor is configured to detect the area on which a gesture for detaching a user interface object is performed. If the area coincides with a user interface object, the processor may be configured to detach a user interface object only after a drag gesture on the user interface object is detected. For example, in FIG. 4a a processor may detect that there are two stationary inputs that at least partially coincide with user interface objects “Image001” and “Video Clips”, respectively. In response to detecting a drag gesture on “Image001” the processor may interpret the stationary input on “Video Clips” as an instruction to detach “Image001” and enable moving the “Image001” file relative to the user interface. Alternatively, in response to detecting a drag gesture on “Video Clips” the processor may interpret the stationary input on “Image001” as an instruction to detach “Video Clips” and enable moving it relative to the user interface. In other words, the processor is configured to detect the specified gesture and to enable detaching a subsequently selected user interface object from the user interface to be moved relative to the user interface.

According to one example embodiment a stationary gesture is interpreted as an instruction to detach a user interface object for as long as an indication of a stationary gesture continues to be received by a processor. According to another example embodiment a stationary gesture is interpreted as an instruction to detach a user interface object until an indication of the same gesture performed again is received by a processor. According to a further example embodiment a stationary gesture is interpreted as an instruction to detach a user interface object until an indication of a completing gesture is received by a processor.

According to one example embodiment a user interface object being moved by a drag gesture relative to a user interface may be dropped in response to removing the stationary gesture. In one example the user interface object may be dropped back to the original position i.e. a move operation may be cancelled, by terminating the gesture for detaching a user interface object from a user interface. In another example the user interface object may be dropped to a destination, i.e. a move operation may be completed, by terminating the gesture for detaching a user interface object from a user interface.

In the example of FIGS. 4b and 4c, after the moving the “Image001” file has been enabled by the processor, a user may move the“Image001” file. In FIG. 4b the user moves the “Image001” file to the “Images” folder 320. In response to dragging the “Image001” file towards the “Images” folder, the appearance of the folder may be changed as illustrated in FIG. 4b. In this example, the background of the “Images” folder has been changed, but any means of visualization may be used to inform the user on a current target. In response to moving the “Image001” file to the “Images” folder, the “Image001” file is stored in the “Images” folder.

An operation such as this, in which an item is moved from one location on a display to another location on the display, is sometimes referred to as a “drag and drop” operation. In this example it can be achieved by performing a stationary gesture on the touch screen and dragging the image file 380 to the “Images” folder, and completing the dragging motion by releasing either the dragging finger or the stationary finger from the touch screen. This set of user inputs is illustrated in FIGS. 4a to 4c.

According to example embodiment, a processor may be configured to return back to the scrolling input mode after completing the move operation. In other words, a user may scroll the user interface 220 partly or as a whole by dragging his finger on the touch screen.

According to one example embodiment, a substantially stationary gesture may be used to distinguish between a touch input intended to result in a scroll operation for the user interface including user interface objects, and a touch input intended to result in a move operation for a user interface object in relation to the user interface. According to another example embodiment a substantially stationary gesture may be used to provide a detach command to detach a user interface object from a user interface. In other words, a substantially stationary gesture may be considered as a command to pin the user interface to enable moving a user interface object independently of the user interface.

According to one example embodiment an instruction to detach one or more user interface objects from the user interface is maintained for as long as a drag gesture coinciding with a user interface object is detected. For example, if a processor receives an instruction to detach a user interface object from the user interface, but a drag gesture is initiated on an empty area of the user interface, with no movable user interface objects in it, the instruction to detach a user interface object may be maintained for as long as the processor receives information that the drag gesture coincides with a user interface object. In this case, if the drag gesture moves from an empty area onto a user interface object, the object will then be moved in accordance with the continuing drag gesture. According to another example embodiment an instruction to detach one or more user interface objects from the user interface is maintained until a pre-determined period of time has elapsed. For example, if a processor receives an instruction to detach a user interface object, but the drag gesture does not coincide with a user interface object until a pre-determined period of time has elapsed, the processor may change the input mode back to a scroll input mode. In other words, the processor may be configured to determine in response to receiving an instruction to detach one or more user interface objects from the user interface, whether a drag gesture coincides with a user interface object, and enable moving the user interface object in response to detecting that the drag gesture coincides with the user interface object. In one example, the processor is configured to move a user interface object with which a drag gesture coincides. In another example, the processor is configured to move a user interface object on which the drag gesture is started. In a further example, the processor is configured to move more than one user interface object with which the drag gesture coincides. For example, the processor may be configured to collect the user interface objects within which the drag gesture coincides. In a yet further example, the processor is configured to move more than one user interface objects simultaneously independently of each other. For example, the processor may be configured to receive information on multiple simultaneous drag gestures on a touch screen and move multiple user interface objects simultaneously, in the same or different directions.

According to one example embodiment the processor may further be configured to receive information on whether a user interface object is detachable from the user interface. For example, a user interface object may be associated with information that it may not be moved, and in response to detecting that a drag gesture coincides with the user interface object the processor may receive the information from the object itself. According to another example embodiment the processor 110 may be configured to determine whether a user interface object is detachable from the user interface. For example, the processor may be configured to determine a type of the user interface object and based on that information determine whether the user interface object may be detached.

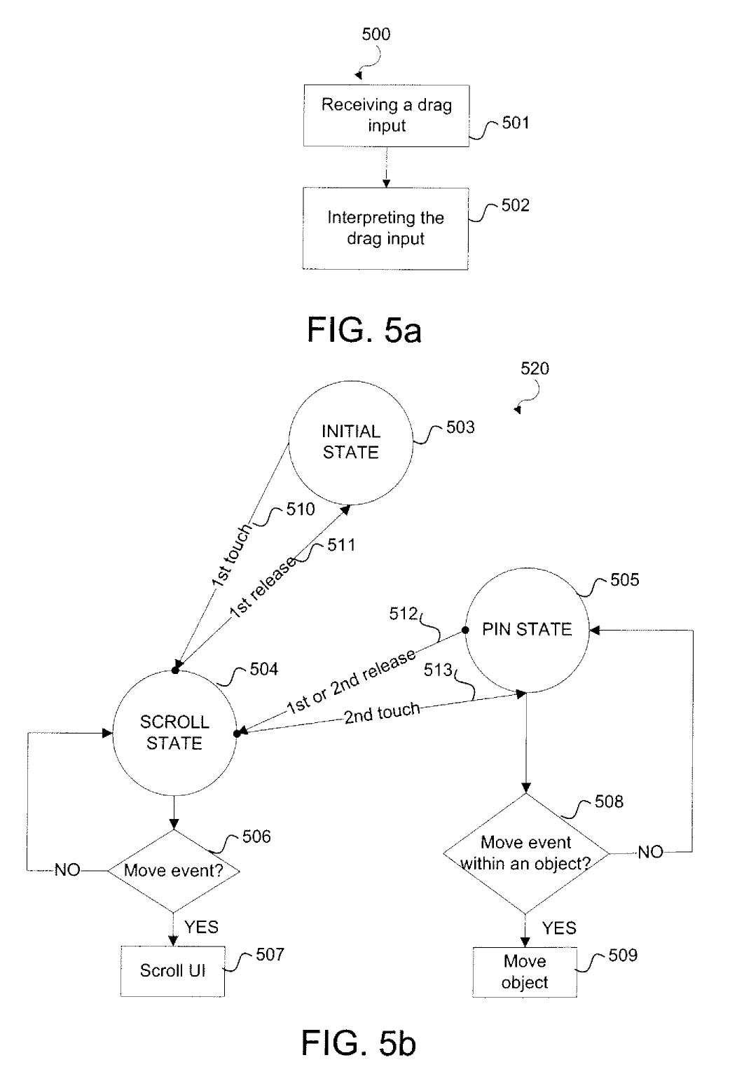

FIG. 5a illustrates an example process 500 incorporating aspects of the previously disclosed embodiments. In a first aspect an indication of a drag input on a user interface object 380 within a user interface 360 on a touch screen is received 501 by the processor 110. According to one example embodiment, a drag input may be performed by a user using a stylus, a digital pen or a finger 340.

In this example, the processor 110 is configured to interpret the drag input 502 as an instruction to detach the user interface object 380 from the user interface 360 in response to receiving a, separate, stationary input on the touch screen. In one example embodiment detaching the user interface object 380 from the user interface 360 comprises enabling moving the user interface object 380 by the processor 110. The user interface object 380 may be moveable independently of the user interface 360 by the processor 110. Additionally or alternatively, the user interface object 380 may be moveable in relation to the user interface 360 by the processor 110. In a further aspect detaching the user interface object 380 comprises enabling keeping the user interface 360 stationary by the processor 110. In other words, the processor 110 may be configured to enable moving the user interface object 380 independently of the user interface 360 by interpreting the stationary input as an instruction to pin the user interface 360.

According to one example embodiment, the drag input and the stationary input may be received substantially simultaneously. According to another example embodiment the stationary input may be received after the drag input has been detected by the processor 110. According to a further example embodiment the drag input may be received after the stationary input has been detected by the processor 110.

In one example embodiment the drag input comprises scrolling the user interface 360 including a user interface object 380. According to one example embodiment scrolling the user interface including a user interface object 380 may comprise scrolling a collection of items such as data files such as audio files, text files, picture files, multimedia files, folders or any other user interface objects. In another example embodiment scrolling the user interface including a user interface object may comprise shifting (panning) the entire contents of the display in a direction corresponding to the scroll direction. This embodiment may be applicable where a large page of information is being displayed on a relatively small display screen, to enable a user to view different parts of the page as he wishes.

In one example embodiment scrolling the user interface 360 with a user interface object 380 may start from any point on the user interface. In another example embodiment, the processor 110 may be configured to determine a drag point in response to receiving an indication of a stationary input. In one example a drag point may be a touch location of the drag input on a touch screen at a time of receiving a stationary input.

In another example embodiment the processor 110 may be configured to determine whether a user interface object 380 comprises a drag point. In one example the processor 110 may be configured to cause detaching the user interface object 140 from the user interface 360 in response to detecting a drag point within the user interface object 380.

In a further example embodiment the processor 110 may be configured to determine whether more than one user interface object 380 comprises a drag point. The processor 110 may be configured to detach more than one user interface object 380 from the user interface 360 in response to detecting a stationary point. For example, more than one picture file may be moved independently of the user interface 360.

In a yet further example embodiment the processor 110 may be configured to detect a swap in a detached user interface object 380. For example, if a user has placed a finger on a first user interface object and stops moving a second user interface object, but still maintains the touch with the second user interface object, a processor 110 may receive an indication of two stationary inputs on a touch screen, each of the stationary inputs coinciding with a user interface object. The processor 110 may be configured to interpret the stationary input on the second user interface object as an instruction to detach the first user interface object from the touch screen and to enable moving the first user interface object in response to detecting a drag input on the first user interface object.

In one example embodiment, if at least two simultaneous stationary inputs are detected and no drag input is detected the processor 110 may be configured to wait until at least one drag input has been detected and enable detaching a user interface object 380 comprising a drag point. For example, if the user has placed one finger to pin the user interface and first moves a first user interface object relative to a user interface with another finger and then stops, two stationary inputs are detected by the processor. The processor then waits until a further drag gesture is detected in terms of either continuing with moving the first interface object or initiating a new drag gesture. If the processor 110 after detecting two stationary gestures detects two drag gestures, the user interface including a user interface object may be scrolled. On the other hand, if the processor 110 after detecting two stationary gestures detects one drag gesture and one stationary gesture, any user interface object with which the drag gesture coincides may be moved relative to the user interface. In other words, the processor 110 may be configured to detect if a user interface object 380 to be moved is swapped from one user interface object to another user interface object without releasing a touch from the touch screen.

According to one example embodiment the processor 110 is configured to interpret a stationary touch gesture as a stationary input. According to another example embodiment the processor 110 is configured to interpret as a stationary input two touch gestures having a difference in speed, wherein the difference is above a threshold value. According to a further example embodiment the processor 110 is configured to interpret as a stationary input multiple touch gestures having a difference in direction, wherein a direction of a single touch gesture differs from a direction of at least two other touch gestures and wherein the direction of the at least two other gestures is substantially the same.

According to one example embodiment the processor 110 is configured to scroll a user interface 360 with a user interface object 380 in response to detecting multiple simultaneous (or substantially simultaneous) drag gestures where the multiple drag gestures move substantially in the same direction. According to another example embodiment the processor 110 is configured to scroll a user interface 360 with a user interface object 380 in response to detecting multiple drag gestures where the multiple drag gestures move substantially at the same speed. According to another example embodiment the processor 110 is configured to scroll a user interface 360 with a user interface object 380 in response to detecting multiple drag gestures where the multiple drag gestures move substantially in the same direction with substantially the same speed.

FIG. 5b illustrates another example process 520 incorporating aspects of the previously disclosed embodiments. In a first aspect the apparatus 100/200 is in an initial state 503. In the example of FIG. 5b, the apparatus 100/200 is in an initial state 503 when no information on one or more inputs is received by the processor 110. According to one example, an input comprises a touch event. The processor 110 is configured to change the apparatus 100/200 from the initial state 503 to a scroll state 504 in response to receiving information on a first touch event 510 on the touch screen. The processor 110 may be configured to return from the scroll state 504 to the initial state 503, if the first touch event is released 511.

In the example of FIG. 5b, a scroll state 504 allows scrolling the user interface 360 together with user interface objects 380. According to one example embodiment, if the processor 110 receives information on a move event 506 in the scroll state 504, the processor 110 enables scrolling 507 the user interface 360 as a whole. According to one example embodiment the move event comprises a drag gesture. The processor 110 may be configured to maintain the scroll state 504 until the first touch event is released 511 or the processor 110 receives information on a second touch event 513.

According to the example of FIG. 5b, the processor 110 is configured to change the apparatus 100/200 from the scroll state 504 to a pin state 505, if the processor 110 receives information on a second touch event 513 in the scroll state 504. A pin state 505 allows moving a user interface object 380 relative to the user interface 360. According to one example embodiment the processor 110 is configured to detach the user interface object 380 from the user interface 360 in response to changing the apparatus 100/200 from the scroll state 504 to the pin state 505. The processor 110 may be configured to return from the pin state 505 to the scroll state 504, if the first touch event or the second touch event is released 512.

According to one example embodiment, if the processor 110 receives information in the pin state 505 on a move event that coincides with a user interface object 508, the processor 110 enables moving the user interface object 509 relative to the user interface 360. The move event may relate to the first touch event or the second touch event. The processor 110 may be configured to maintain the pin state 505 until the first event or the second touch event is released 512.

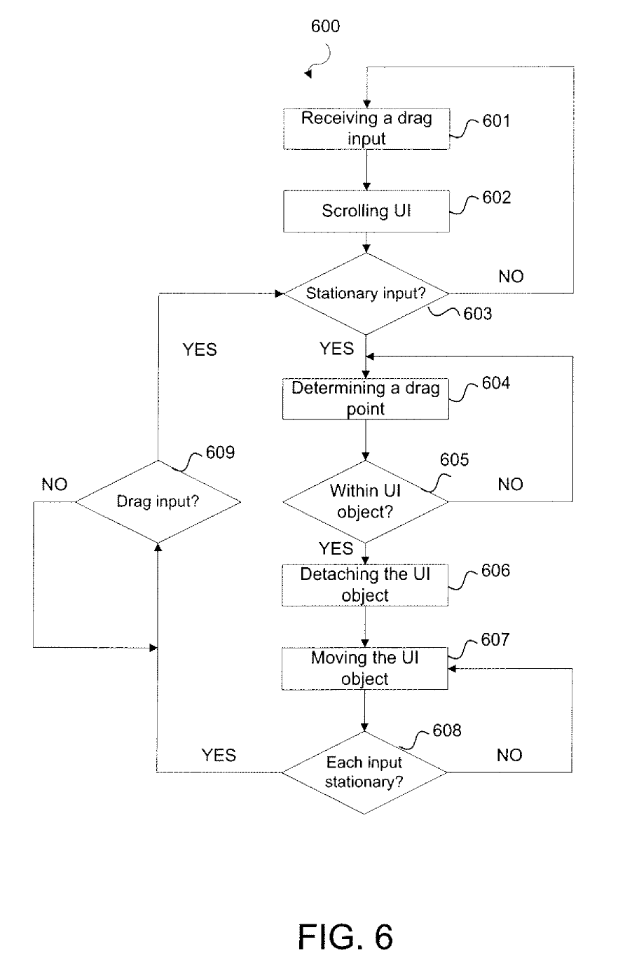

FIG. 6 illustrates another example process 600 incorporating aspects of the previously disclosed embodiments. In a first aspect an indication of a drag input is received 601 by the processor 110. A drag input may be performed on a touch screen by a user by using a finger or a stylus, for example. According to one example embodiment performing a drag input may comprise using more than one finger, for example, a user may scroll the user interface including a user interface object within the user interface by using two, three or more fingers. In the example of FIG. 6, the processor 110 is configured to cause scrolling 602 a user interface in response to receiving the drag input.

According to the example process of FIG. 6, the processor 110 is configured to determine 604 a drag point in response to receiving 603 a stationary input on the touch screen. In one example a drag point may be a touch location of the drag input on a touch screen at a time of receiving a stationary input. After determining the drag point, in step 605 it is determined whether the drag point is at least partially contained in a user interface object within the user interface. If the drag point is not contained in a user interface object the drag point may be updated until it is at least partially contained in a user interface object. According to one example embodiment the drag point may be updated in response to detecting a change in the position of the drag input on the touch screen until the drag input has finished. According to another example embodiment the drag point may be updated until the stationary input is released.

According to the example of FIG. 6, the processor 110 is configured to detach 606 a user interface object at least partially coinciding with the drag point from the user interface. Detaching a user interface object from a user interface may comprise any one or more of the following examples, either alone or in combination: controlling the user interface object independent of the user interface, enabling moving the user interface object independently of the user interface, moving a user interface object relative to the user interface and/or keeping the user interface stationary. In the example process of FIG. 6, the processor 110 is configured to move the user interface object relative to the user interface. In one example, more than one user interface object may be detached in response to detecting a drag point at least partially within each of the more than one user interface objects. For example, in response to detecting a drag point that coincides within two or more user interface objects, the two or more user interface objects may be detached by the processor 110.

An example embodiment of FIG. 6 enables a user to swap, on the fly, a first user interface object to a second user interface object and move the second user interface object relative to the user interface. In one example, when the processor 110 receives an indication that each input detected on a touch screen is stationary 608, the processor 110 waits until a drag input is detected and the processor 110 receives an indication of the detected drag input. In response to detecting at least one drag input and at least one stationary input, a new drag point may be determined by the processor 110. In other words, a user may at any time change the user interface object to be moved relative to the user interface.

According to one example embodiment a user interface object may be pinned and the user interface may be moved relative to the pinned user interface object. For example, a user may input a stationary input on a user interface object and the processor 110 is configured to move the user interface relative to the user interface object in response to detecting a drag input.

Without in any way limiting the scope, interpretation, or application of the claims appearing below, a technical effect of one or more of the example embodiments disclosed herein is to automatically distinguishing between an attempt to scroll a user interface and an attempt to move a user interface object relative to the user interface. Another technical effect of one or more of the example embodiments disclosed herein is that a user may change from one mode to another with a reduced number of operations in terms of not needing to select an operation in a menu. Another technical effect of one or more of the example embodiments disclosed herein is that changing from a scroll operation to a move operation and vice versa may be changed on the fly. Another technical effect of one or more of the example embodiments disclosed herein is that one gesture may be used for two different operations by interpreting the gesture differently in different situations.

Embodiments of the present invention may be implemented in software, hardware, application logic or a combination of software, hardware and application logic. The software, application logic and/or hardware may reside on the apparatus, a separate device or a plurality of devices. If desired, part of the software, application logic and/or hardware may reside on the apparatus, part of the software, application logic and/or hardware may reside on a separate device, and part of the software, application logic and/or hardware may reside on a plurality of devices. In an example embodiment, the application logic, software or an instruction set is maintained on any one of various conventional computer-readable media. In the context of this document, a “computer-readable medium” may be any media or means that can contain, store, communicate, propagate or transport the instructions for use by or in connection with an instruction execution system, apparatus, or device, such as a computer, with one example of a computer described and depicted in FIG. 2. A computer-readable medium may comprise a computer-readable storage medium that may be any media or means that can contain or store the instructions for use by or in connection with an instruction execution system, apparatus, or device, such as a computer.

If desired, the different functions discussed herein may be performed in a different order and/or concurrently with each other. Furthermore, if desired, one or more of the above-described functions may be optional or may be combined.

Although various aspects of the invention are set out in the independent claims, other aspects of the invention comprise other combinations of features from the described embodiments and/or the dependent claims with the features of the independent claims, and not solely the combinations explicitly set out in the claims.

It is also noted herein that while the above describes example embodiments of the invention, these descriptions should not be viewed in a limiting sense. Rather, there are several variations and modifications which may be made without departing from the scope of the present invention as defined in the appended claims.

What is claimed is:

1. A method, comprising:
receiving an indication of a first drag input on a user interface object within a user interface on a touch screen; and
in response to receiving a stationary input on the touch screen, interpreting the first drag input as an instruction to detach the user interface object from the user interface.

2. A method according claim 1, further comprising receiving an indication of a second drag input and interpreting the second drag input as an instruction to scroll the user interface together with the user interface object if no stationary input is detected.

3. A method according claim 2, comprising scrolling a collection of items.

4. A method according to claim 1, further comprising moving the user interface object independently of the user interface.

5. A method according to claim 4, further comprising keeping the user interface stationary.

6. A method according to claim 1, wherein the drag input and the stationary input are received substantially simultaneously.

7. A method according to claim 1, further comprising determining a touch location of the drag input at the time of receiving the stationary input and detaching the user interface object if the user interface object coincides with the touch location.

8. An apparatus, comprising:
a processor,
memory including computer program code, the memory and the computer program code configured to, working with the processor, cause the apparatus to perform at least the following:
receive an indication of a first drag input on a user interface object within a user interface on a touch screen; and
in response to receiving a stationary input on the touch screen, interpret the first drag input as an instruction to detach the user interface object from the user interface.

9. An apparatus of claim 8, wherein the processor is further configured to receive an indication of a second drag input and to interpret the second drag input as an instruction to scroll the user interface together with the user interface object if no stationary input is detected.

10. An apparatus of claim 8, wherein the processor is configured to move the user interface object independently of the user interface.

11. An apparatus of claim 10, wherein the processor is configured to keep the user interface stationary.

12. An apparatus of claim 8, wherein the processor is configured to determine a touch location of the drag input at the time of receiving the stationary input and to detach the user interface object if the user interface object coincides with the touch location.

13. A computer program product comprising a computer-readable medium bearing computer program code embodied therein for use with a computer, the computer program code comprising:
code for receiving an indication of a first drag input on a user interface object within a user interface on a touch screen; and
code for interpreting the first drag input as an instruction to detach the user interface object from the user interface in response to receiving a stationary input on the touch screen.

14. A computer program product according to claim 13, further comprising code for receiving an indication of a second drag input and interpreting the second drag input as an instruction to scroll the user interface together with the user interface object if no stationary input is detected.

15. A computer program product according to claim 13, further comprising code for moving the user interface object independently of the user interface.

16. A computer program product according to claim 15, further comprising code for keeping the user interface stationary.

17. A computer program product according to claim 13, further comprising code for determining a touch location of the drag input at the time of receiving the stationary input and code for detaching the user interface object if the user interface object coincides with the touch location.

18. An apparatus, comprising:
means for receiving an indication of a first drag input on a user interface object within a user interface on a touch screen; and
means for interpreting the first drag input as an instruction to detach the user interface object from the user interface in response to receiving a stationary input on the touch screen.
